(19) United States
(12) Patent Application Publication
(10) Pub. No.: US 2017/0027381 A1
(43) Pub. Date: Feb. 2, 2017

(54) COOKING APPLIANCE WITH DIRECT CONTACT COOKING GRATE

(71) Applicant: Spectrum Brands, Inc., Middleton, WI (US)

(72) Inventors: David William Everett, JR., Verona, WI (US); Karl Warner Marschke, Madison, WI (US)

(21) Appl. No.: 15/218,785

(22) Filed: Jul. 25, 2016

Related U.S. Application Data
(60) Provisional application No. 62/197,369, filed on Jul. 27, 2015.

(51) Int. Cl. A47J 37/06; G05B 19/042; A47J 36/00

(52) U.S. Cl. CPC A47J 37/0629; A47J 37/0664; A47J 36/00; G05B 19/0426; G05B 2219/2613

(57) ABSTRACT

In a cooking appliance, the appliance generally includes at least one cooking grate having a first rail, a second rail, and a plurality of rods extending between the first and second rails in spaced relationship with each other, each of the plurality of rods having a respective heating element such that the at least one cooking grate facilitates directly contacting a food product with a plurality of the heating elements during cooking.

### PRIORITY CLAIM

This application claims the benefit of U.S. Provisional Application having Ser. No. 62/197,369, filed on Jul. 27, 2015, which is incorporated herein by reference in its entirety.

### BACKGROUND

The present invention relates generally to cooking appliances used for baking foods, and more particularly to heating elements used in such cooking appliances.

Cooking appliances such as portable or tabletop cooking appliances that are used for cooking or baking food products are well known. At least some such appliances heat a first plate using a heating element, and then conduct heat from the first plate to a second plate that contacts the food product. Accordingly, the food product is indirectly heated, as it is not in direct contact with either the heating element or the first plate. Further, when meat is cooked on at least some known cooking appliances, fat may fall onto a cooking surface, burning and creating smoke.

There is need, therefore, for a cooking appliance that heats food products more directly and more quickly, and that facilitates preventing fat from falling onto a cooking surface.

### SUMMARY

In one embodiment, a cooking appliance generally comprises at least one cooking grate comprising a first rail, a second rail, and a plurality of rods extending between the first and second rails in spaced relationship with each other, each of the plurality of rods comprising a respective heating element such that the at least one cooking grate facilitates directly contacting a food product with a plurality of the heating elements during cooking.

In another embodiment, a cooking grate for use in a cooking appliance generally comprises a first rail, a second rail, and a plurality of rods extending between the first and second rails in a spaced relationship with each other, each of the plurality of rods comprising a respective heating element such that the at least one cooking grate facilitates directly contacting a food product with a plurality of the heating elements during cooking.

### BRIEF DESCRIPTION

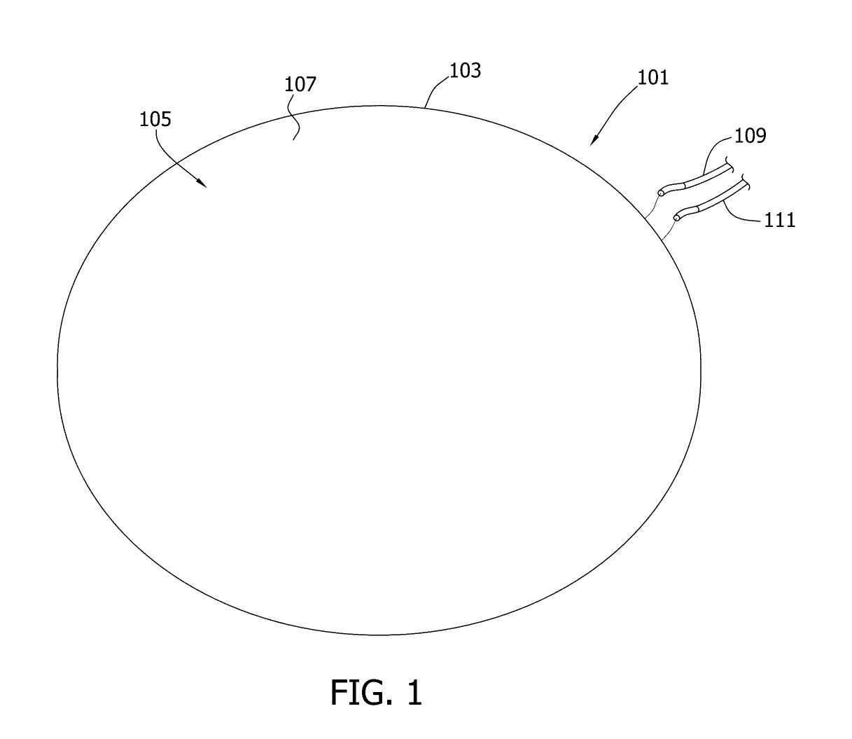

FIG. 1 is a bottom view of a baking plate in accordance with one embodiment of the present disclosure;

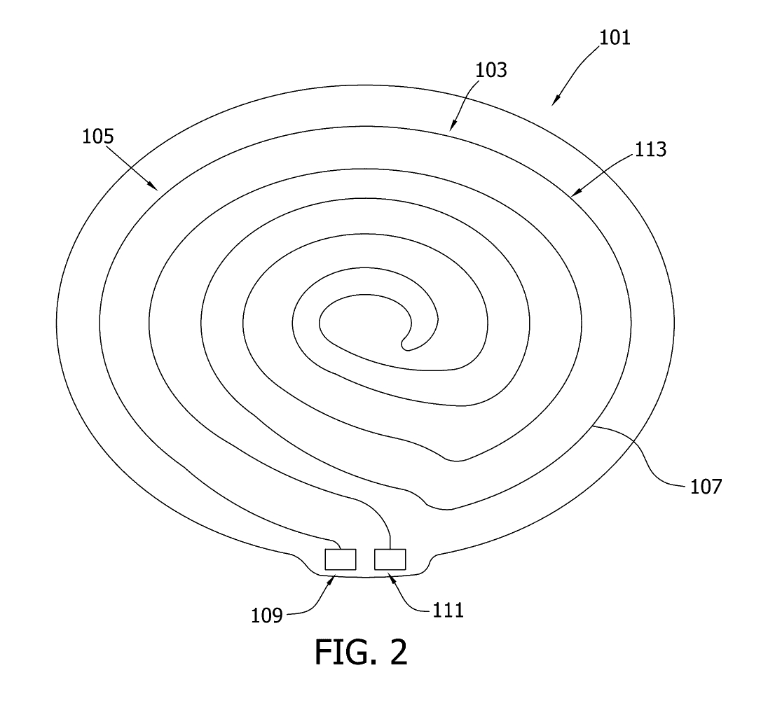

FIG. 2 is a schematic illustration of the baking plate of FIG. 1 showing an embedded heating element;

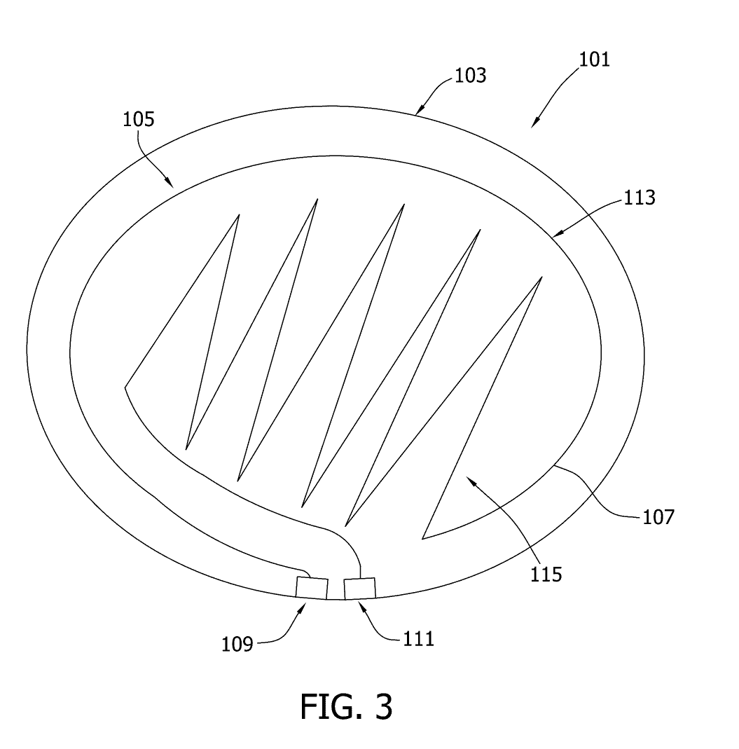

FIG. 3 is a schematic illustration of the baking plate of FIG. 1 showing another embodiment of an embedded heating element;

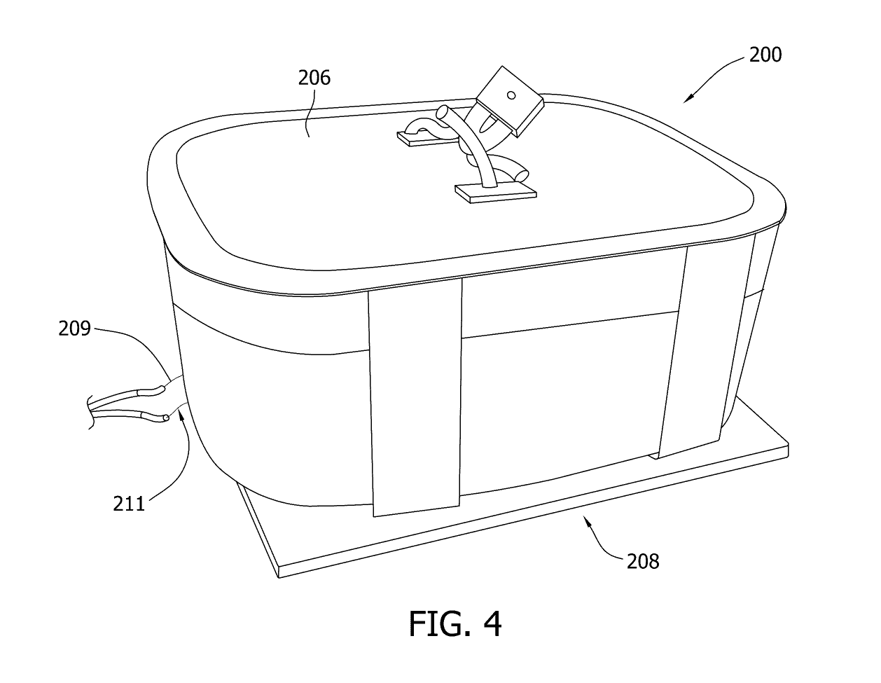

FIG. 4 is a perspective view of a cooking appliance in accordance with one embodiment of the present disclosure;

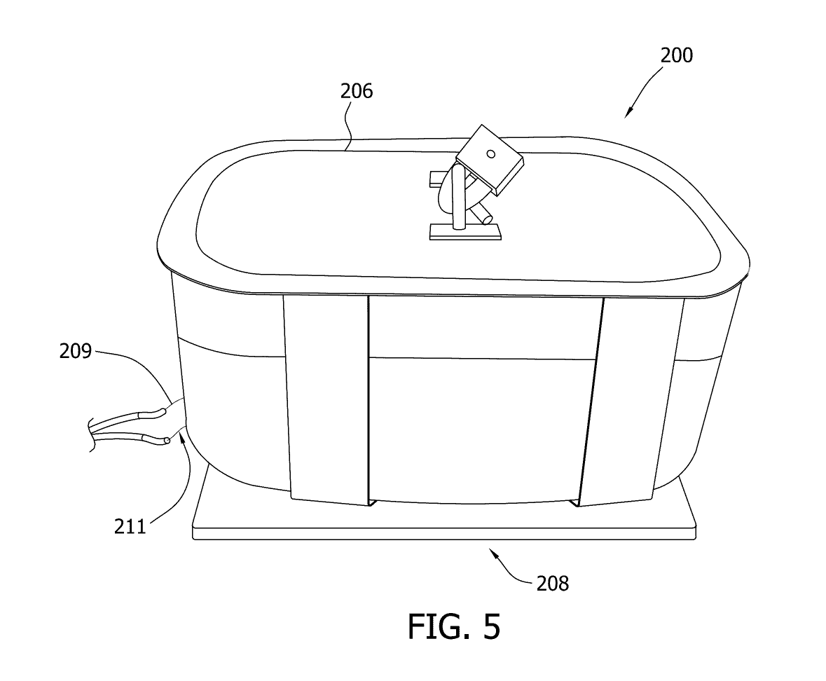

FIG. 5 is a front view thereof;

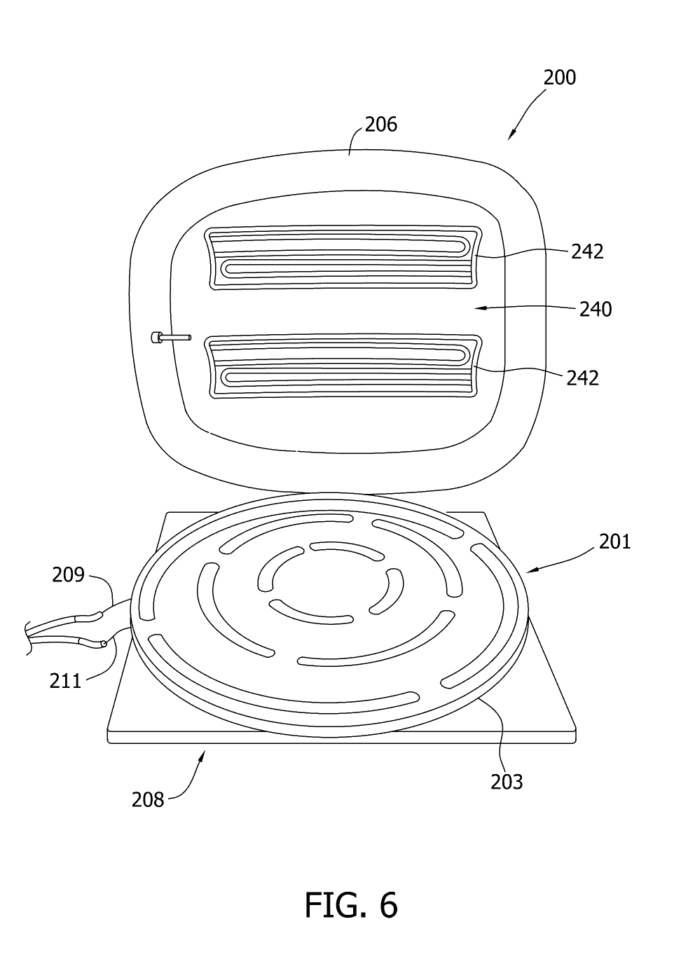

FIG. 6 is a front view of the cooking appliance of FIG. 5 with a housing of the cooking appliance in an opened position;

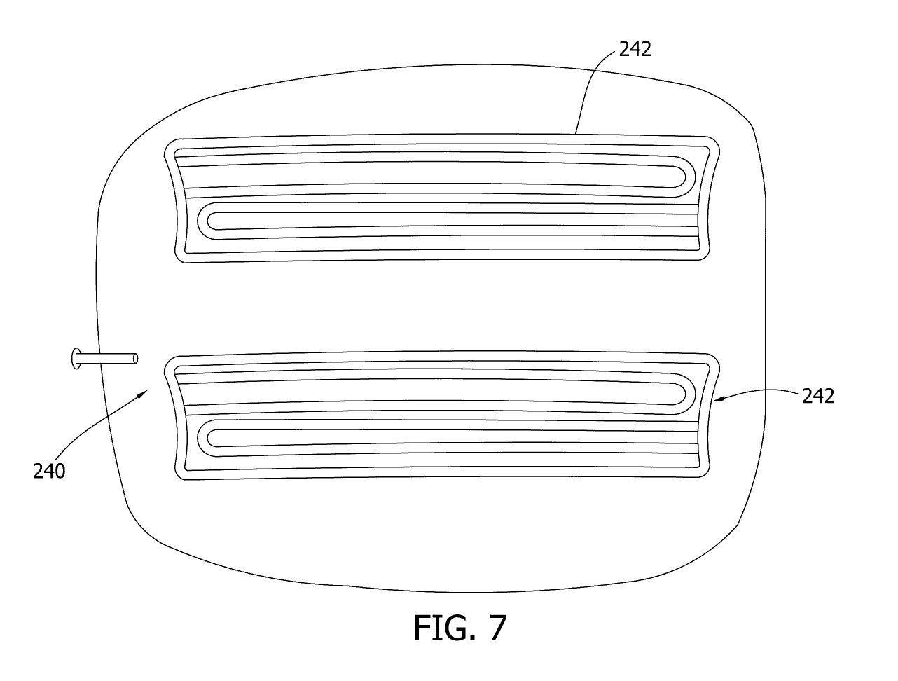

FIG. 7 is a bottom view of a top heating element of the cooking appliance of FIG. 4;

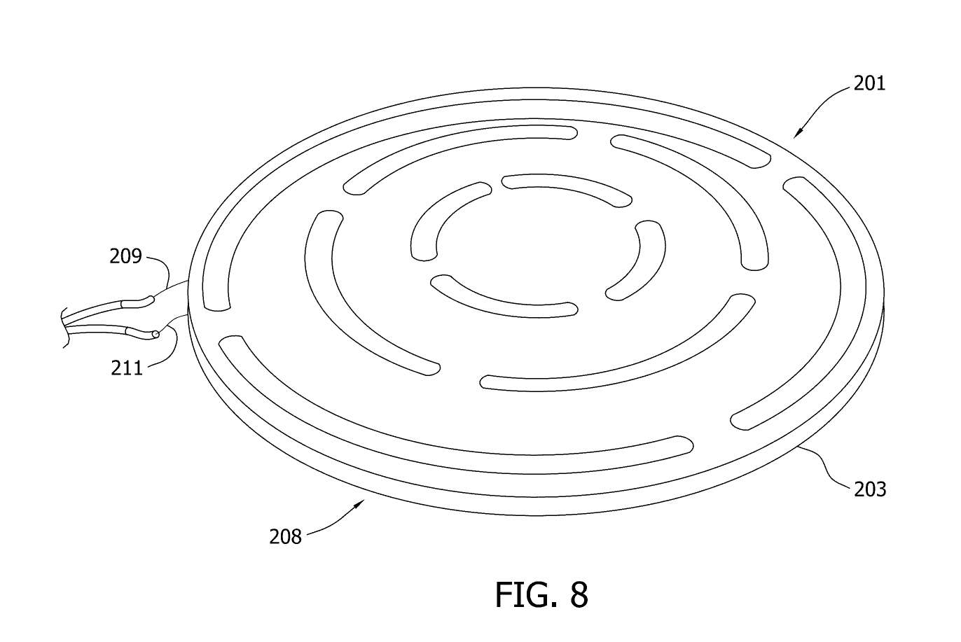

FIG. 8 is a top view of a baking plate of the cooking appliance of FIG. 4;

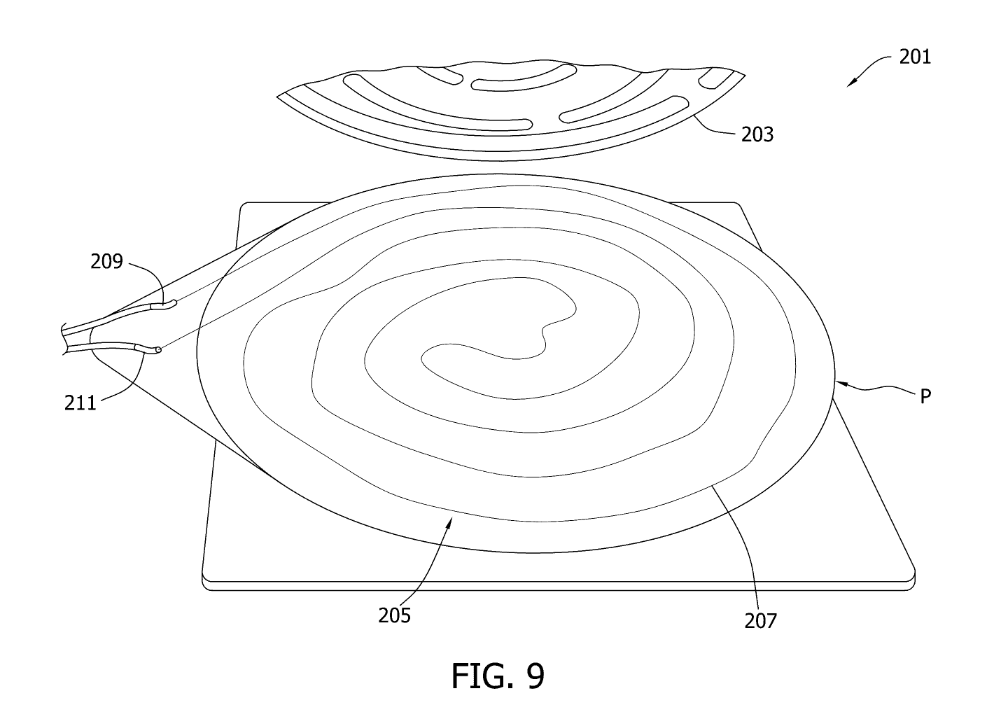

FIG. 9 is a top view of a heating element of the baking plate of FIG. 8;

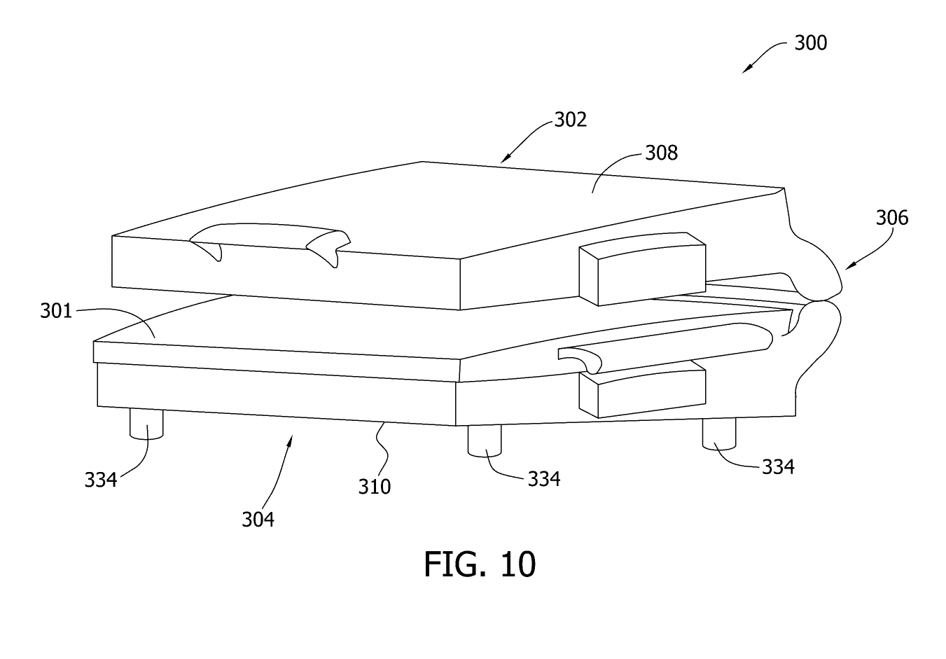

FIG. 10 is a perspective view of another embodiment of a cooking appliance;

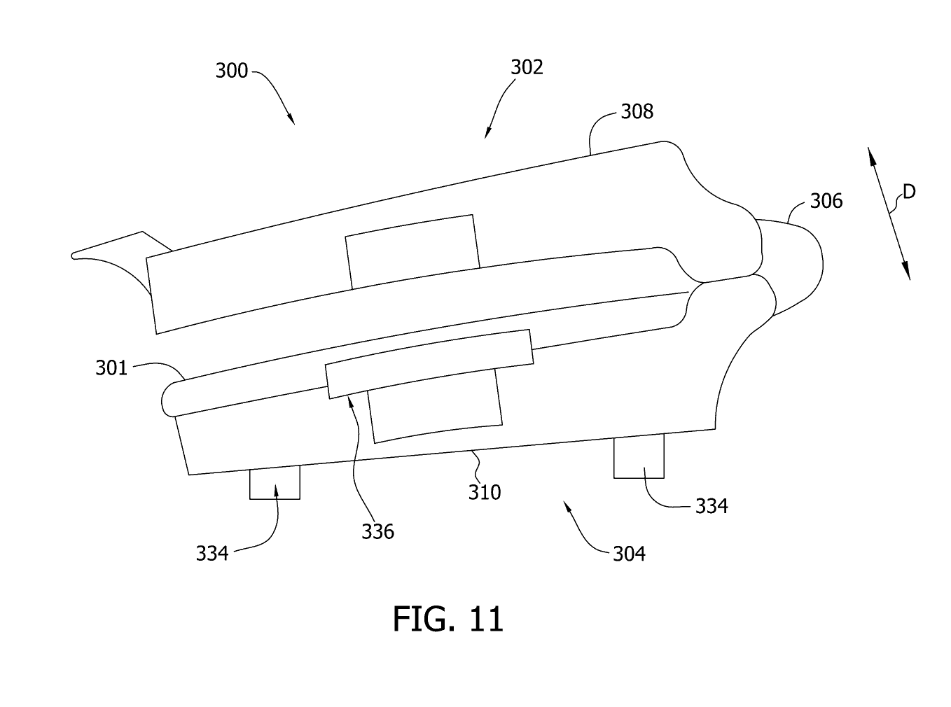

FIG. 11 is a side view of the cooking appliance of FIG. 10;

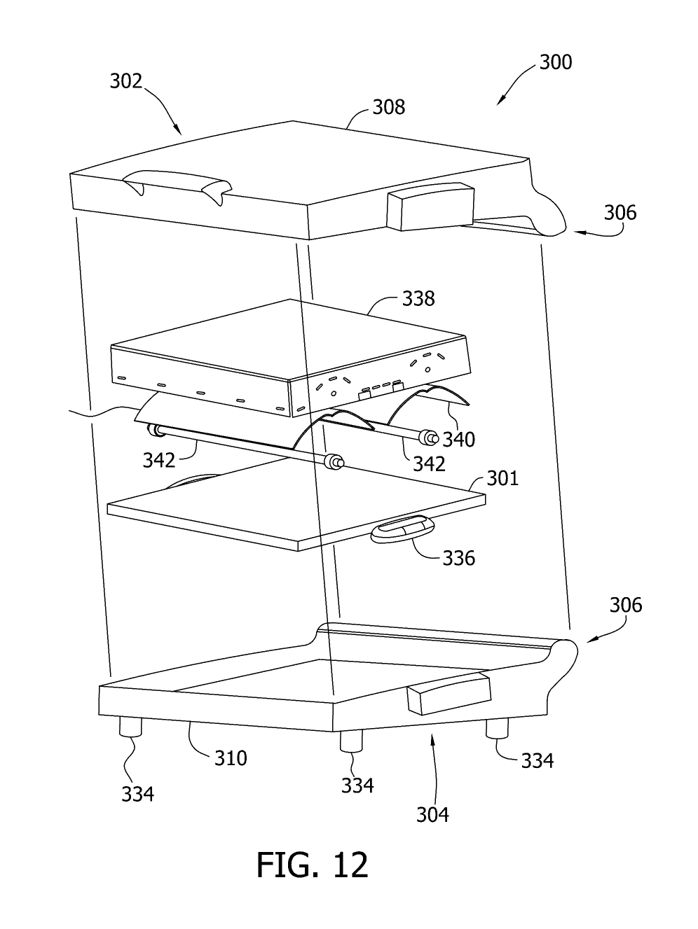

FIG. 12 is an exploded view of the cooking appliance of FIG. 10;

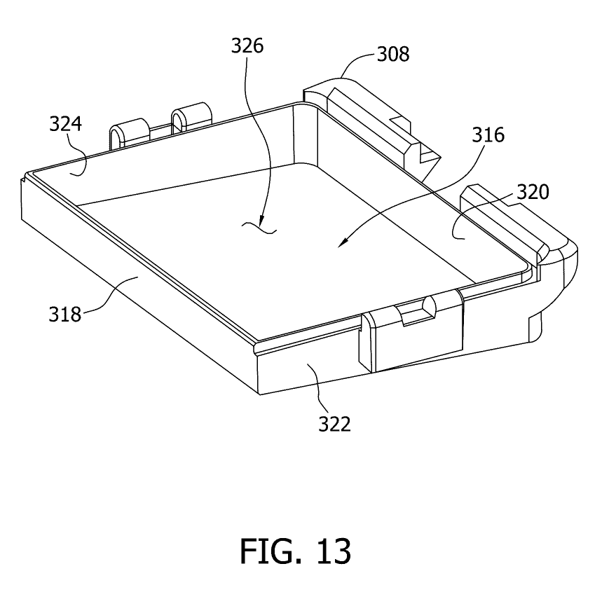

FIG. 13 is a perspective view of an upper housing of the cooking appliance of FIG. 10;

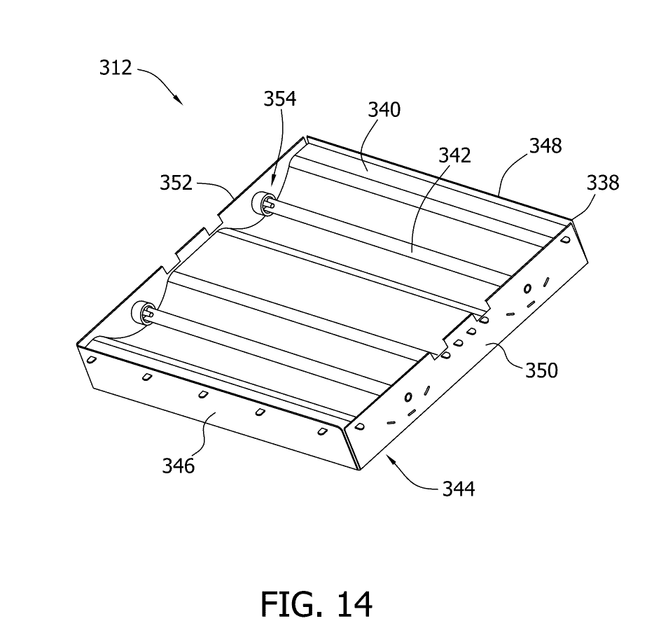

FIG. 14 is a perspective view of a core insert for the upper housing of the cooking appliance of FIG. 10;

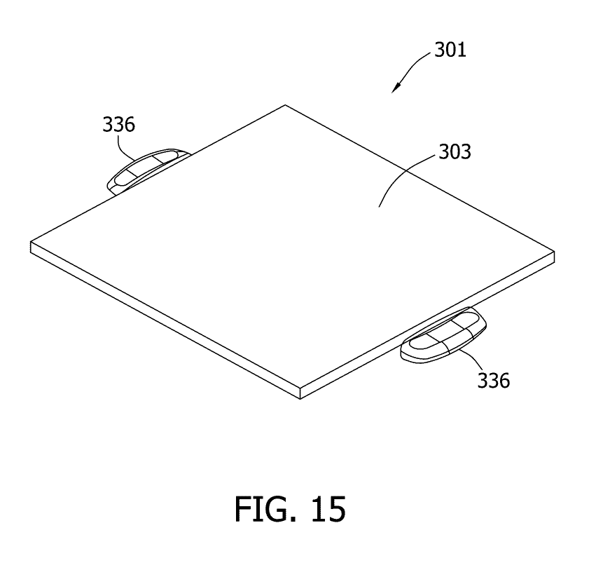

FIG. 15 is a top perspective view of a baking plate of the cooking appliance of FIG. 10;

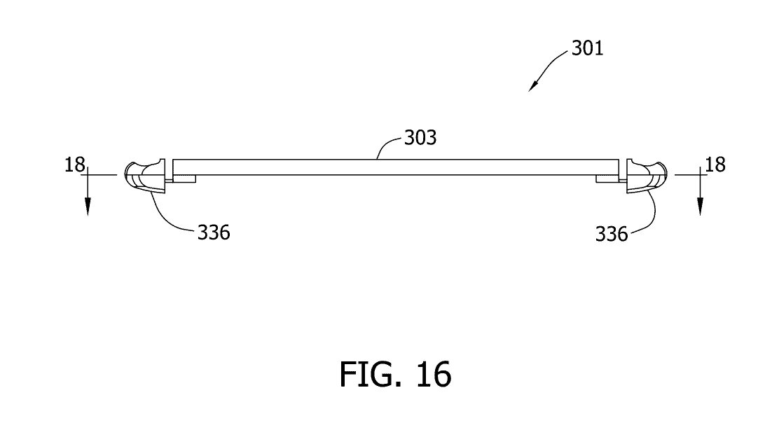

FIG. 16 is a front view of the baking plate of FIG. 15;

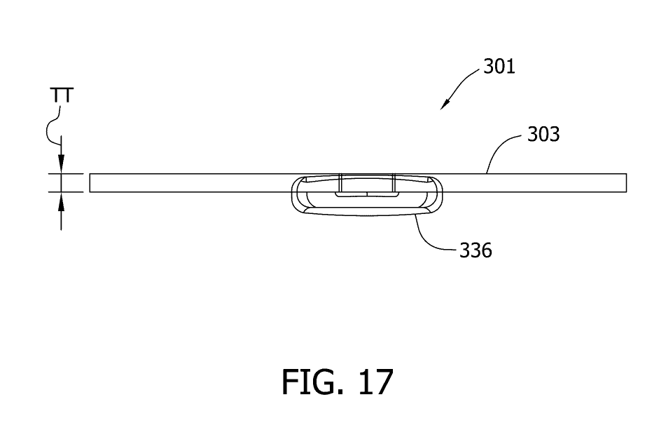

FIG. 17 is a side view of the baking plate of FIG. 15;

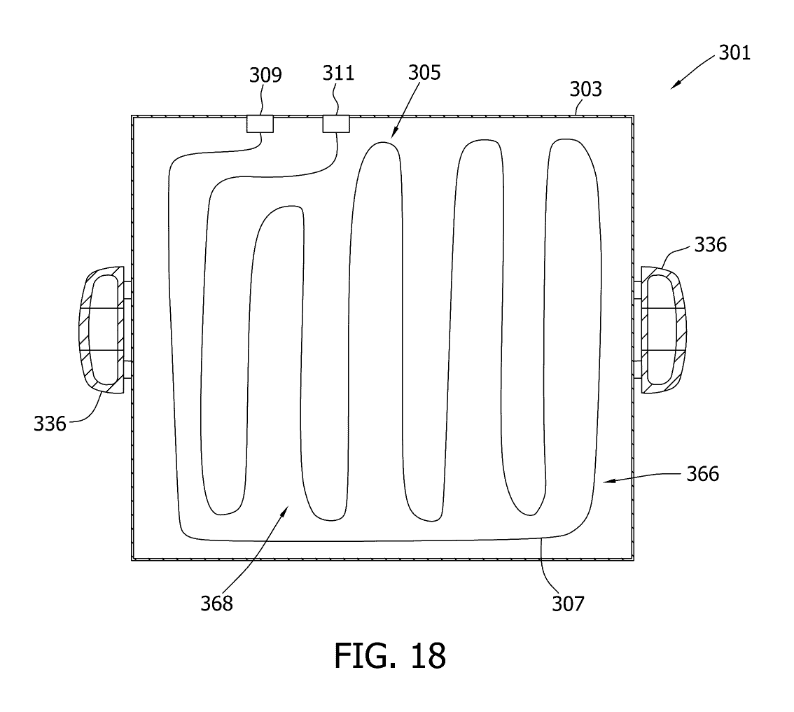

FIG. 18 is a cross-section taken in the plan of line 18-18 of FIG. 16;

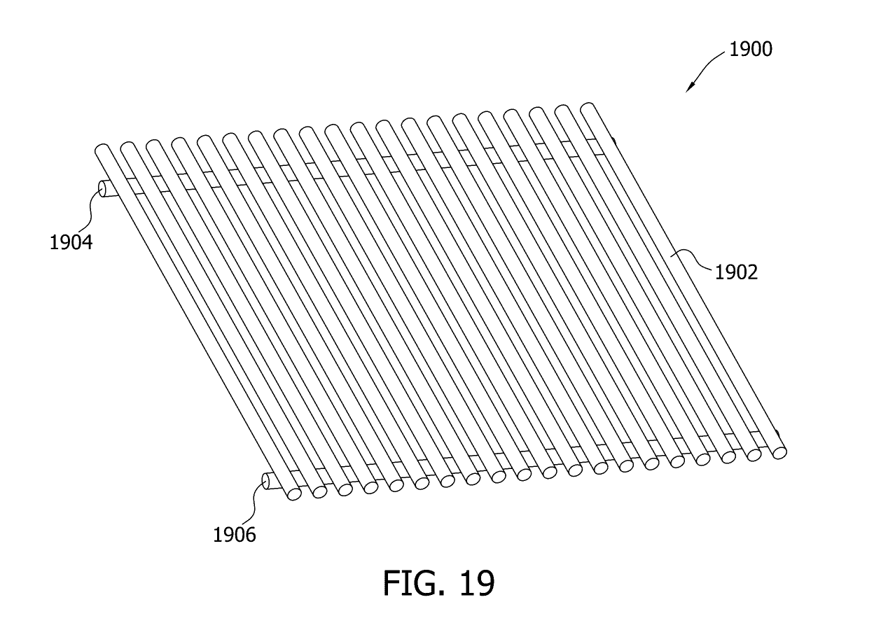

FIG. 19 is a perspective of a cooking grate in accordance with one embodiment of the present disclosure;

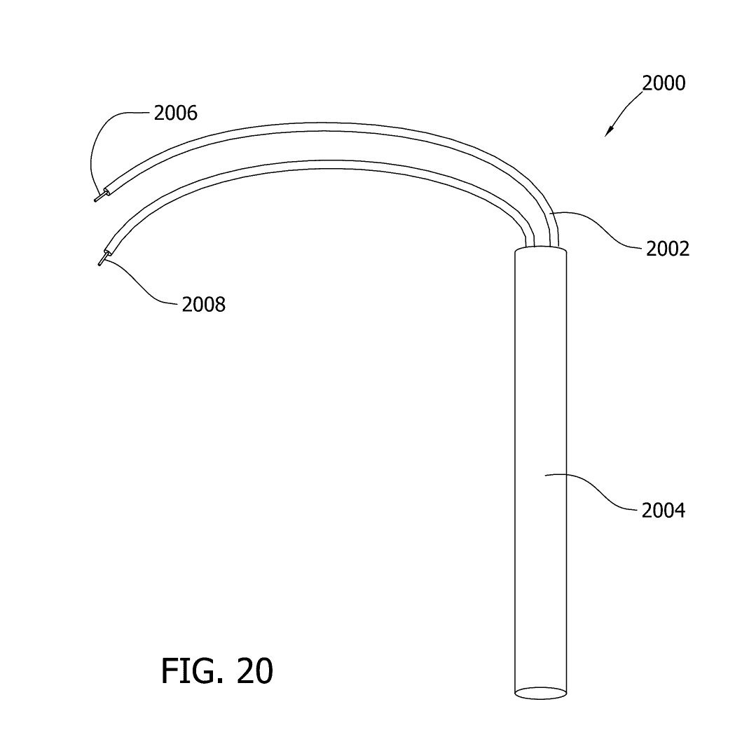

FIG. 20 is a perspective view of a heating element that may be used with the grate shown in FIG. 19;

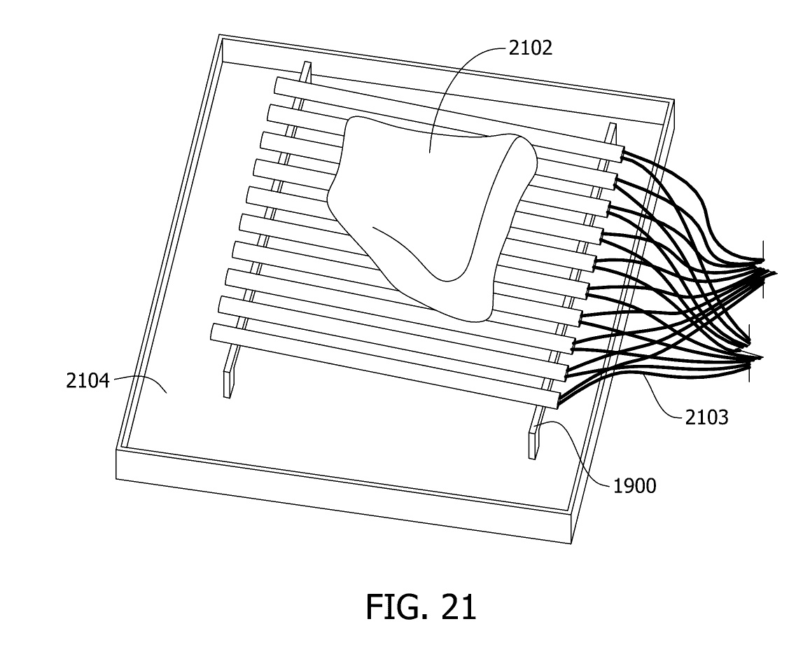

FIG. 21 is a perspective view of a food product being cooked using the grate shown in FIG. 19;

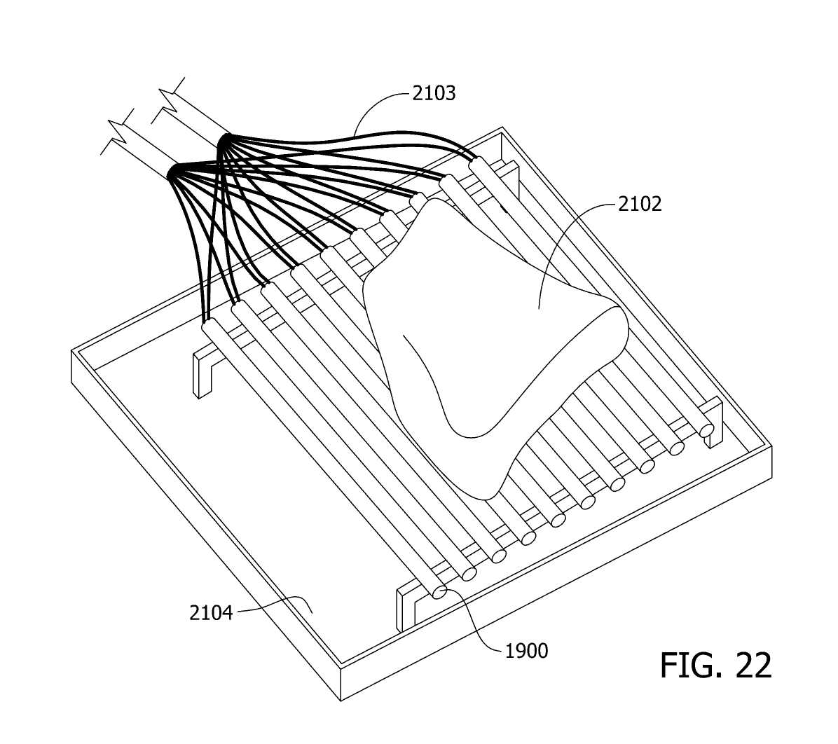

FIG. 22 is a perspective view of a food product being cooked using the grate shown in FIG. 19;

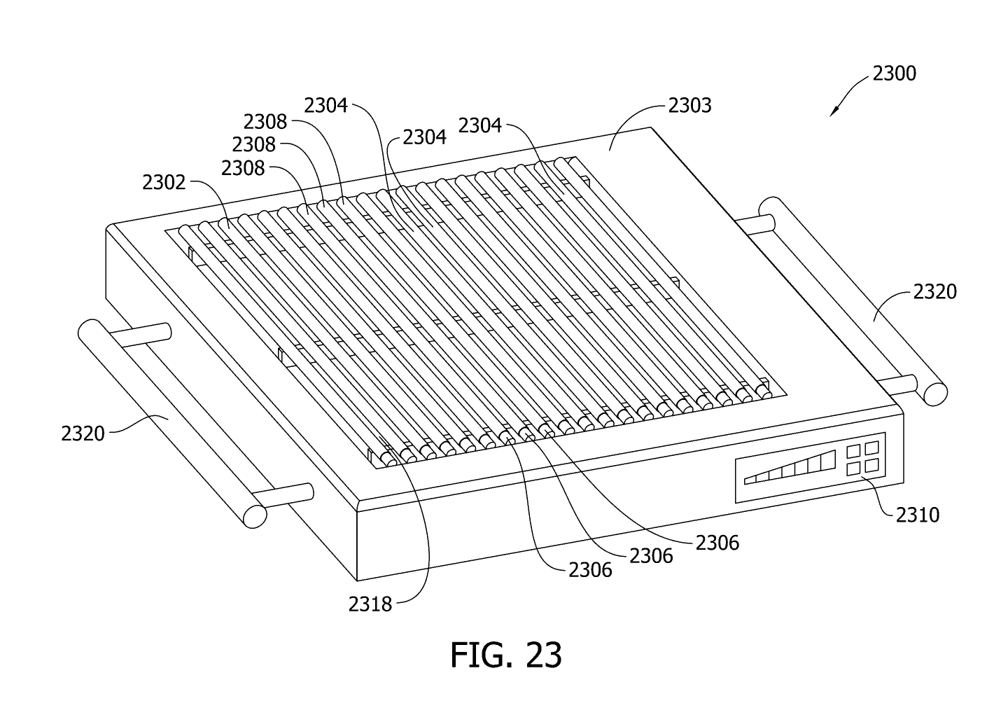

FIG. 23 is perspective view of a cooking appliance with a grate according to the present disclosure;

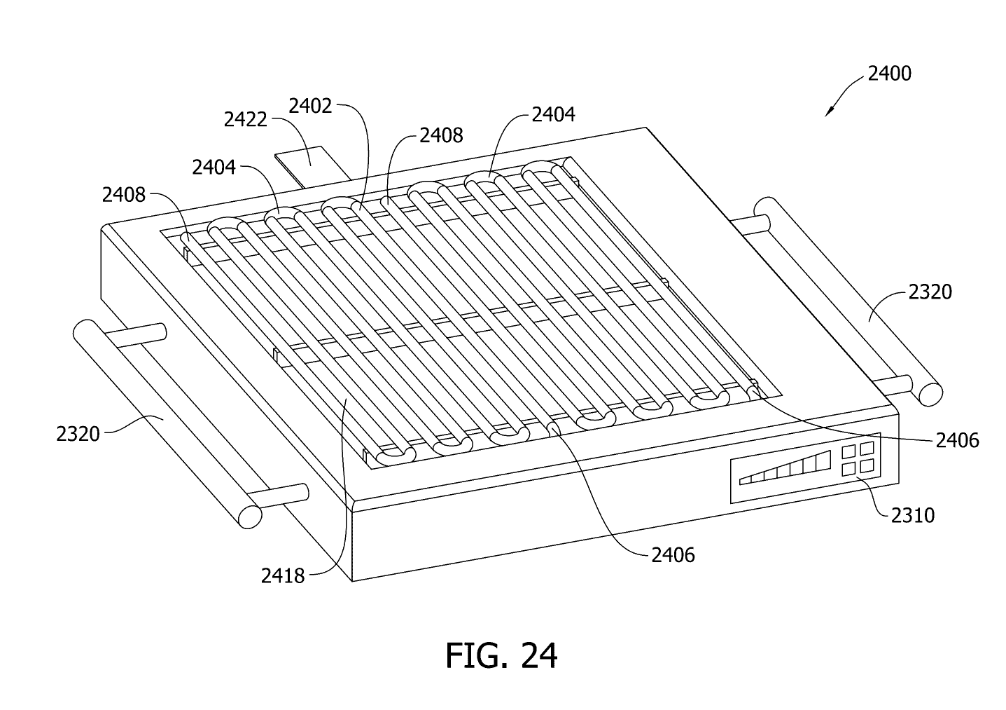

FIG. 24 is a perspective view of an alternative cooking appliance with a grate according to the present disclosure;

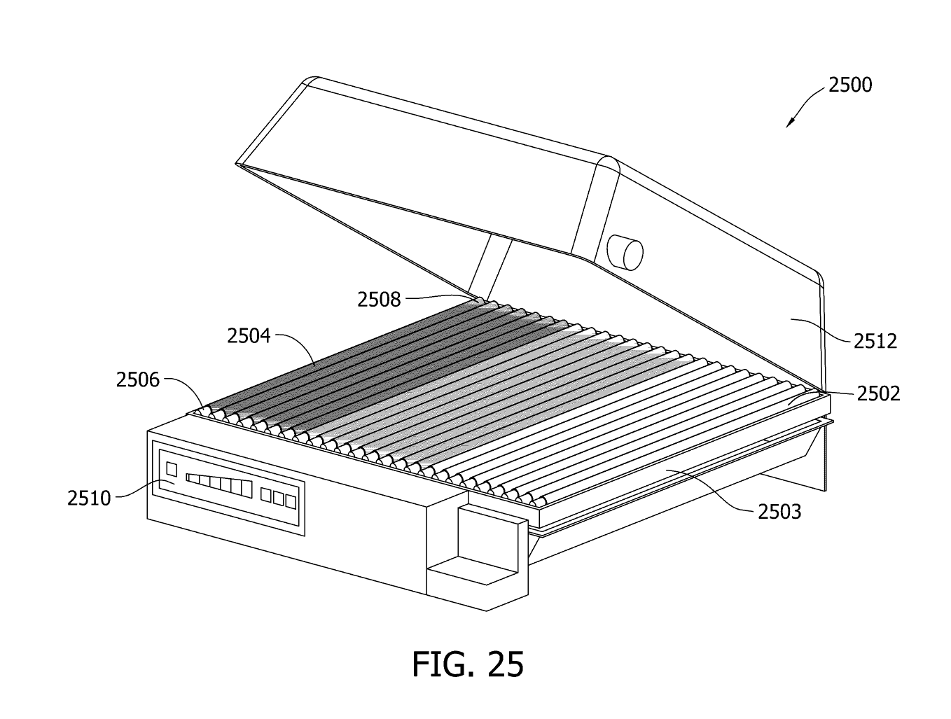

FIG. 25 is a perspective view of another alternative cooking appliance with a grate according to the present disclosure;

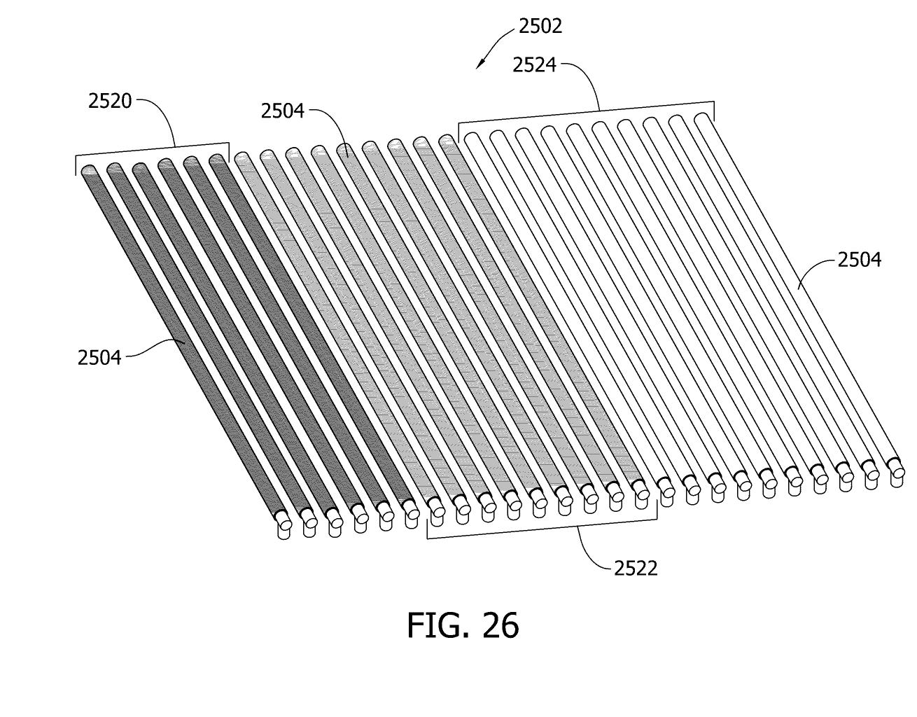

FIG. 26 is a perspective view of the grate of FIG. 25 and according to the present disclosure;

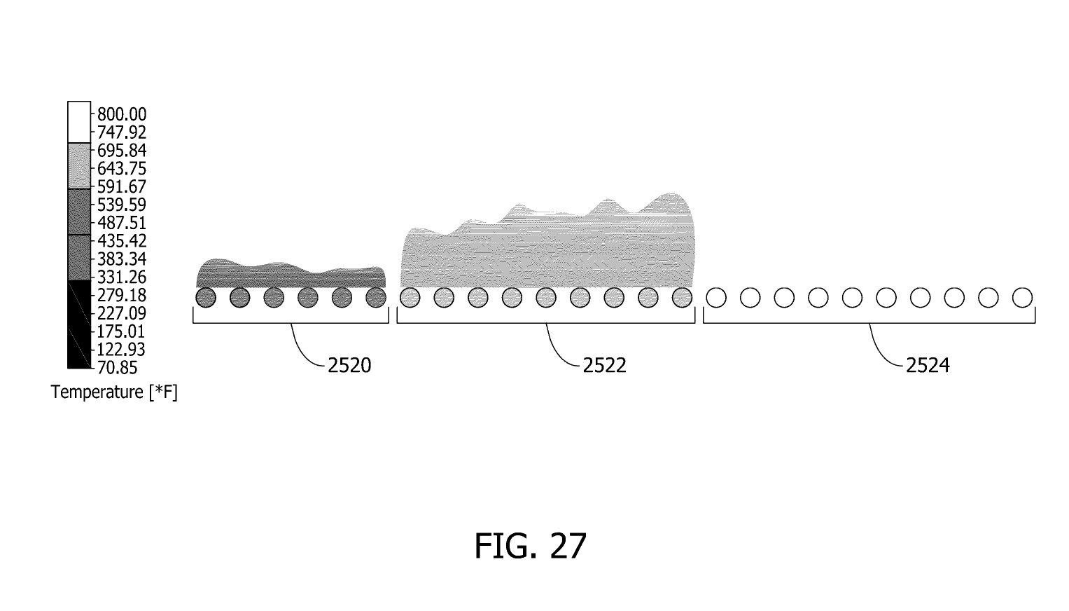

FIG. 27 is a thermal map of the cooking appliance of FIG. 25 during cooking;

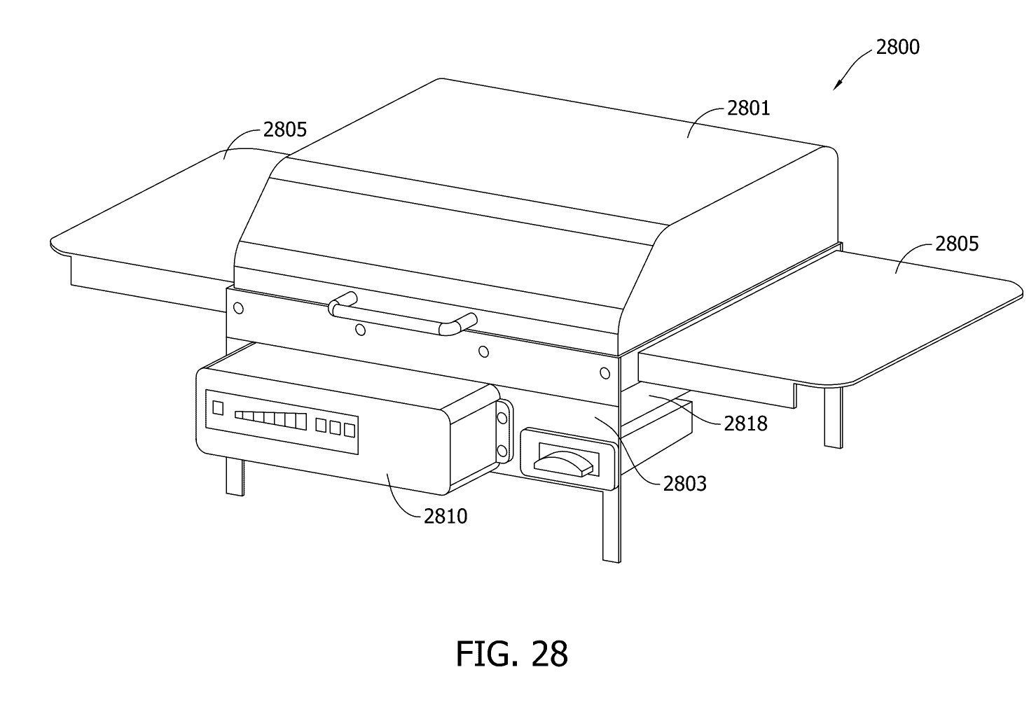

FIG. 28 is a perspective view of yet another alternative cooking appliance with a grate according to the present disclosure;

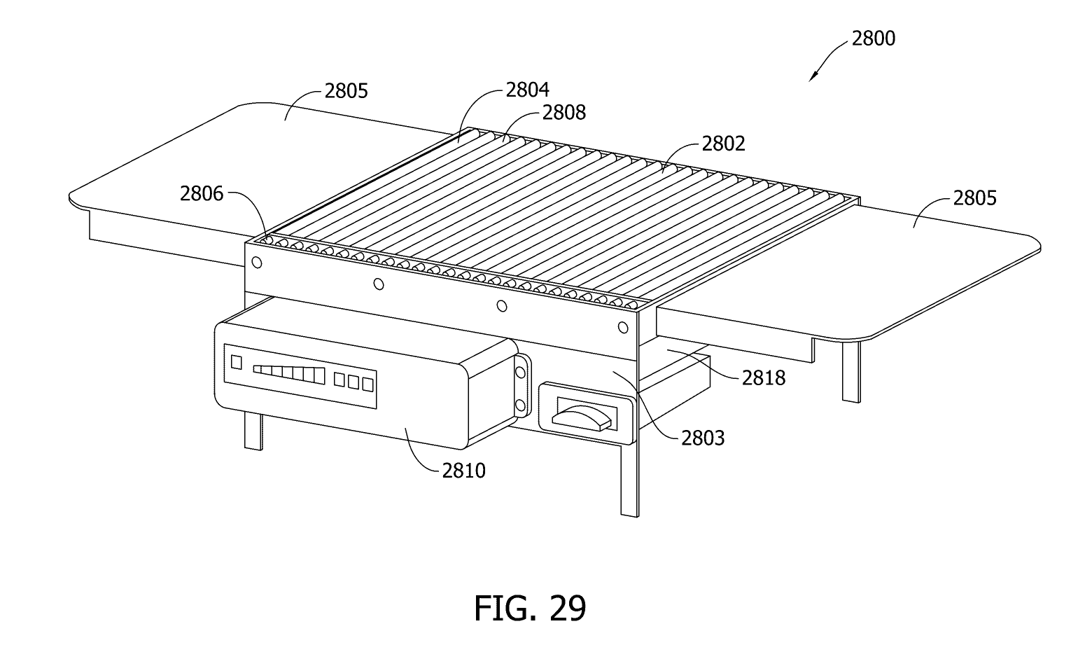

FIG. 29 is a perspective view of the cooking appliance of FIG. 28 with the cover removed to show the cooking grate; and

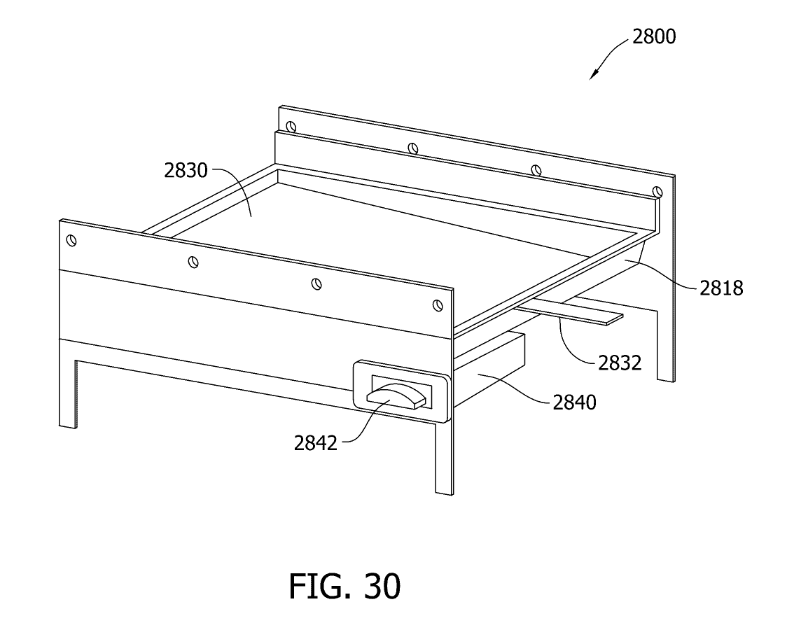

FIG. 30 is a perspective view of the cooking appliance of FIG. 28 with cover, grate, support surfaces removed.

Corresponding reference characters indicate corresponding parts throughout the several views of the drawings.

### DETAILED DESCRIPTION

With reference now to the drawings and in particular to FIGS. 1 and 2, a baking plate according to one embodiment of the present disclosure is generally indicated at 101. The baking plate 101, as disclosed herein, is intended for use with a cooking appliance used for baking crusted-type foods such as breads, pizza, calzones, and other foods that are typically baked on a baking tray in a conventional oven. In a particular embodiment, the cooking appliance is a portable or tabletop cooking appliance having a heating source to apply heat to the food to be baked. The baking plate 101 comprises a generally solid plate member 103 and a heating element 105 at least in part embedded within the plate member 103. While one or more segments of the heating element 105 are visible in FIG. 1, it is understood that the heating element may be entirely enclosed within the plate member 103 and otherwise not visible from the exterior of the plate member.

The plate member 103 of the baking plate 101 is suitably constructed of a high insulative material, such as, without limitation, ceramic, clay, stone, or other suitable high insulative material. The illustrated plate member 103 is generally circular, such as in the form that is commonly referred to as a pizza stone. However, it is understood that the plate member 103 may be other than circular without departing from the scope of this disclosure.

The heating element 105, according to one embodiment, is an electrically conductive wire and in one particular embodiment is a nichrome wire that is arranged in a continuous pattern within the plate member 103. For example, FIG. 2 illustrates one embodiment of a pattern formed by a wire 107 that defines the heating element 105. The wire 107 includes a pair of terminals 109, 111 at the edge margin of the plate member 103 for connection with a suitable source of electrical current. The wire 107 is arranged to form a plurality of circular winds 113 spaced radially from each other and from the edge margin of the plate member 103 toward the center thereof. In an alternative embodiment, illustrated in FIG. 3, the wire 107 is arranged to have an outermost circular wind 113 and a zig-zag pattern 115 within the outermost wind.

It is understood that in other embodiments the wire 107 may be arranged within the plate member 103 in any suitable pattern that covers a substantial area of the plate member. The wire 107 according to one embodiment may have a length (e.g., as measured from one terminal 109 to the other terminal 111) in the range of about 100 inches to about 140 inches. However, the length of the wire 107 may be less than or greater than this range, and may vary depending on the overall size or surface area of the plate member 103. It is also contemplated that more than one wire 107 may be used to define the heating element 105 without departing from the scope of this disclosure.

FIGS. 4-9 illustrate one embodiment of a cooking appliance, generally indicated at 200, for baking crusted-type foods. The cooking appliance 200 is illustrated in a mock-up assembly of representative components including a baking plate 201 constructed in accordance with the present disclosure. In particular, with reference to FIGS. 4-6, the cooking appliance is an oven-type cooking appliance including a base panel 208 and a housing 206 removably positionable relative to the base panel such that the housing and base panel together define an interior space of the cooking appliance. The baking plate 201 is seated on the base panel within the interior space of the cooking appliance when the housing is closed over the base panel. The housing 206 may be hinged to the base panel 208 or may be completely separable from the base panel.

It is understood that the oven-type cooking appliance 200 may be configured other than as illustrated in FIGS. 4-7. For example, the cooking appliance 200 may be configured as a front-loading oven (e.g., in the manner of what is typically referred to as a toaster-oven), or with a base unit supporting the base panel elevated above the surface (e.g., counter-top) on which the appliance sits, or other suitable configuration.

As illustrated in FIGS. 6 and 7, an upper heating system 240 includes a pair of heating elements 242 held by the housing 206 for disposition above the baking plate 201. While not shown in the drawings, one or more reflectors may be mounted on the housing 206 for reflecting heat from the heating elements 242 downward within the interior space toward the baking plate 201.

The baking plate 201, with particular reference to FIGS. 6, 8 and 9, is substantially the same as the baking plate 101 of FIG. 1 in that it comprises a generally circular solid plate member 203 and a heating element 205. For illustrative purposes, the heating element 205 is shown as being arranged on a pad P that is placed beneath the plate member. However, in practice, the heating element is embedded in the plate member as illustrated in FIG. 1. The heating element of this embodiment is a wire 207 arranged in the pattern illustrated in FIG. 2. It is understood, however, that the wire 207 may be arranged in the pattern illustrated in FIG. 3 or in any other suitable pattern. It is also understood that more than one wire 207 may be used to define the embedded heating element without departing from the scope of this invention. The heating element 205 is electrically connected at its terminals 209, 211 to a source of electrical current—which in one embodiment is the same source of electrical current to which the upper heating system 240 is electrically connected.

In operation, before food is placed in the cooking appliance 200, the appliance is turned on to supply current to the upper heating system 240 as well as to the heating element 205 of the baking plate 201. In this manner, the plate member 203 of the baking plate 201 is brought up to a desired temperature more rapidly along with the air temperature (e.g., due to the upper heating system 240) in the interior space of the appliance. The food to be baked is then placed on the upper surface of the baking plate. In one embodiment, the heating element 205 of the baking plate 201 may be controlled to reduce or terminate heating of the plate member 203 after a predetermined time period, or after a threshold temperature of the interior space and/or the plate member is reached. In other embodiments, the heating element 205 may be maintained at constant heating for the entire cooking period of the food to be baked.

FIGS. 10-18 schematically illustrate another embodiment of a cooking appliance, generally indicated at 300, for baking crusted-type foods. In particular, the cooking appliance 300 of this embodiment is an open broiler-type cooking appliance including a baking plate 301 constructed in accordance with the present disclosure. As illustrated in FIGS. 10 and 11, the cooking appliance 300 of this embodiment comprises a top unit (indicated generally by 302) and a bottom unit (indicated generally by 304) that are connected together via a hinge 306. The top unit 302, with reference to FIGS. 12-14 includes a housing 308 and a core insert (indicated generally by 312 in FIG. 14) disposed within the housing 308. As illustrated in FIG. 13, the housing 318 includes a top wall 316, a first end wall 318, a second end wall 320, a first side wall 322, and a second side wall 324 that together define an interior space 326 sized to receive the core insert 312 (FIG. 14).

The core insert 312 is suitably configured for attachment to the top housing 308 within the interior space 326. The core insert 312 includes a frame 338, a reflector 340, and at least one top heating element 342. The frame 338 has a top wall 344, a first end wall 346, a second end wall 348, a first side wall 350, and a second side wall 352 that define a cavity 354 in which the reflector 340 and the top heating element(s) 342 are disposed. The walls 346, 348, 350, and 352 have a receiving mechanism for receiving and retaining the reflector 340 and the top heating element(s) 342 therein. Notably, in other embodiments, the top unit 302 may not include the frame 338 but, rather, the top housing 308 may perform the function of supporting the reflector 340 and/or the top heating element(s) 342 in the manner set forth herein. The illustrated top heating elements 342 are suitably quartz-type heating elements formed as a substantially linearly extending tube. However, it is understood that the top heating elements 342 may be any known heating elements other than quartz-type heating elements and remain within the scope of this disclosure.

Referring back to FIGS. 10-12 the bottom unit 304 includes a bottom housing 310 and the baking plate 301 supported by the bottom housing. The bottom housing 310 may have at least one leg (or stand) 334 configured such that, when the appliance 300 is seated on a surface such as a counter-top, the baking plate 301 is oriented generally level or otherwise parallel to the counter-top. As illustrated in FIGS. 12 and 15-18, the baking plate 301 has a pair of handles 336 connected thereto, and the handles 336 are configured to interface with the bottom housing 310 to facilitate detachable connection (e.g., magnetic connection) of the baking plate with the bottom housing. This allows the baking plate 301 to be removable from the bottom housing 310 for cleaning or replacement.

As in the previous embodiments, the baking plate 301 includes a plate member 303 and a heating element 305 (FIG. 18) at least in part embedded in the plate member. In this embodiment, the plate member 303 is generally rectangular in shape but is otherwise constructed in any manner described above in connection with baking plate 301 of FIGS. 10-12. The heating element 305 is suitably a wire 307 of similar construction to the wire 107 of the baking plate 101 of FIGS. 1-3. As illustrated in FIG. 18, the wire 307 is arranged with an outer circumferential wind 366 and a serpentine pattern 368 within the outer circumferential wind. The wire 307 is electrically connected at terminals 309, 311 to a suitable source of current such as the same current source to which the top heating elements 342 are electrically connected.

With reference back to FIGS. 11 and 12, the hinge 306 enables the top unit 302 to be pivoted relative to the bottom unit 304 between a raised position for loading food to be baked onto the baking plate 301 and a lowered position for baking the food on the baking plate. The hinge 306 is suitably configured to allow the top unit 302 to be adjustably positioned relative to the bottom unit 304 along a direction D to a desired height above the baking plate 301 to accommodate foods of different thicknesses to be baked on the baking plate.

FIG. 19 is a perspective view of a cooking grate 1900 according to one embodiment of the present disclosure. Similar to baking plates 101, 201, and 301, grate 1900 is a cooking element that may be used to heat and grill or cook a food product. In the embodiment shown in FIG. 19, the grate 1900 includes a plurality of rods 1902 extending between a first rail 1904 and a second rail 1906. In this embodiment, the rods 1902 are substantially cylindrical, with a diameter of approximately 0.25 inches. Alternatively, the rods 1902 may have any shape and dimension that enables the grate 1900 to function as described herein.

To facilitate heating the grate 1900, heating elements (not shown in FIG. 19) are inserted into the rods 1902 or form the rods 1902 themselves, as described herein. FIG. 20 is a perspective view of one embodiment of a heating element 2000 that may be used with the grate 1900. In this embodiment, heating element 2000 is a cartridge heater. The cartridge heater is heated by running a current through a wire 2002 that extends within a housing 2004. The wire 2002 includes a first terminal 2006 and a second terminal 2008 for connecting the wire 2002 to a power source that supplies the current. Within the housing 2004, a resistance wire (e.g., nickel-chromium) is wound through a magnesium oxide core that surrounds the wire 2002. An outer sheath of the housing 2004 may be formed, for example, from stainless steel. The thickness of the outer sheath corresponds to the robustness of the housing 2004. Accordingly, the thickness of the outer sheath may be increased as needed to improve the overall robustness of the housing 2004. Notably, in the embodiments described herein, food products grilled using the heating element 2000 directly contact the housing 2004 of the cartridge heater.

In this embodiment, the wire 2002 enters and exits the housing 2004 at the same end of the housing 2004. Alternatively, the wire 2002 may enter the housing 2004 at a first end, and exit the housing 2004 at a second, opposite end. In such embodiments, multiple wires 2002 may extend through the housing 2004 to facilitate evenly heating the housing 2004. The housing 2004 may include, for example, stainless steel or a nickel alloy. In some embodiments, the housing 2004 includes a non-conductive jacket.

For the grate 1900, the cartridge heater heating element 2000 may be inserted within a rod 1902 (i.e., by inserting the housing 2004 into the rod 1902). Alternatively, the housing 2004 itself may constitute the rod 1902.

A cartridge heater is one example of a heating element that may be used in the grate 1900. In other embodiments, heating elements may include Calrod® heaters (Calrod is a registered trademark of General Electric Company, a New York Corporation), quartz rods, thin film heaters, and/or resistive heating wires (e.g., nichrome wires, iron chromium wires, etc.). The heating elements may be coiled within the rods 1902 or extend substantially linearly within the rods 1902. Moreover, the heating elements may be embedded within the rods 1902 in a non-conductive power (e.g., magnesium oxide). For example, a Calrod® heating element includes a coiled heating wire extending through magnesium oxide insulation, and the magnesium oxide insulation is encased in a metallic (e.g., steel) pipe.

The heating elements for each rod 1902 may be controlled together (i.e., such that each rod 1902 is operated at substantially the same temperature) or controlled individually such that the temperature of each rod 1902 can be selectively adjusted independent of the temperatures of the other rods 1902. Further, in some embodiments, a temperature sensor is inserted in at least one rod 1902 to facilitate tracking and monitoring the current temperature of the at least one rod 1902. The temperature may be actively adjusted based on the monitoring. Moreover, in some embodiments, a current sensor monitors current flow through at least one rod 1902. If the monitored current exceeds a predetermined threshold (e.g., in the event that a liquid contacts the rod 1902), the current sensor may cause the current through the rod 1902 to be limited.

FIGS. 21 and 22 are perspective views of the grate 1900 being used to cook food products 2102. Wires 2103 used to supply current to heating elements in the grate 1900 are also shown in FIGS. 21 and 22. In FIGS. 21 and 22, the grate 1900 is oriented substantially horizontally, such that the grate 1900 provides a substantially rigid structure that supports the food product 2102 during cooking. Alternatively, the grate 1900 may be oriented substantially vertically.

Further, in some embodiments, instead of being rigid members, the rods 1902 are flexible, or spring-loaded, such that when the food product 2102 is placed on the grate 1900, the rods 1902 flex to contour to the shape of the food product 2102, facilitating increased surface contact between the grate 1900 and the food product 2102.

In FIGS. 21 and 22, a tray 2104 is positioned below the grate 1900. When the food product 2102 is cooked on the grate 1900, fat from the food product 2102 falls through the grate 1900 and lands on the tray 2104. Because the tray 2104 is at a lower temperature than the grate 1900 during cooking, the tray 2104 prevents the fat from burning and generating smoke when contacting the tray 2104.

The grate 1900 described herein may be implemented in many different cooking appliances. For example, the grate 1900 may be used instead of the baking plate 201 in the cooking appliance 200 (shown in FIGS. 4-9). Further, the grate 1900 may be used instead of the baking plate 301 in the cooking appliance 300 (shown in FIGS. 10-12). For example, in cooking appliance 300, the grate 1900 could be included in the top unit 302 or the bottom unit 304. Further, in one embodiment, two grates 1900 could be used in cooking appliance 300, with one grate 1900 housed in the top unit 302, and one grate 1900 housed in the bottom unit 304.

FIG. 23 is a perspective view of a cooking appliance 2300 according to one embodiment of the present disclosure. The cooking appliance 2300 includes a grate 2302 positioned on a housing 2303. The grate 2302 is similar to the grate 1900 (shown in FIGS. 19, 21, and 22). Specifically, the grate 2302 includes plurality of substantially linear rods 2304 each extending from a first end 2306 to a second end 2308. The grate 2302 includes twenty rods 2304 in this embodiment. Alternatively, the grate 2302 may include any suitable number of rods 2304.

In this example embodiment, each rod 2304 is a heating element, such as cartridge heater. Accordingly, food products cooked on the grate 2302 are in direct contact with heating elements. Alternatively, each rod 2304 may include a heating element inserted within a separate component (e.g., a hollow tube).

In this embodiment, similar to the grate 1900, the wiring for each rod 2304 enters and exits each rod 2304 at the same end (e.g., the first end 2306). Alternatively, for each rod 2304, wiring may enter one end (e.g., the first end 2306) and exit another end (e.g., the second end 2308).

The cooking appliance 2300 includes a control interface 2310 that enables a user to control operation (e.g., temperature) of the grate 2302. The control interface 2310 may include buttons, knobs, switches, and/or any other suitable input device that enables a user to operate the cooking appliance 2300.

The grate 2302 may include multiple zones (each including one or more rods 2304) that are independently controllable. For example, the grate 2302 may include two separate zones (e.g., a left half of the grate 2302 and a right half of the grate 2302). Alternatively, the grate 2302 may include a single controllable zone (including all of the rods 2304), or each rod 2304 may be independently controllable. In one embodiment, the temperature of each zone may be set between approximately 300° Fahrenheit (F) and 700° F., and the cooking appliance 2300 operates has a power output of approximately 1400 Watts (W) at 120 Volts (V). Alternatively, the cooking appliance 2300 may have any suitable operating parameters.

A drip tray 2318 is positioned below the grate 2302. Accordingly, when cooking a food product, grease from the food product falls through the grate 2302 into the drip tray 2318. The drip tray 2318 is removable from the housing 2303 to dispose of collected grease. Accordingly, the drip tray 2318 may include a handle (not shown in FIG. 23) to facilitate removing the drip tray 2318. The cooking appliance 2300 further includes a pair of handles 2320 to facilitate transporting the cooking appliance 2300.

FIG. 24 is a perspective view of an alternative cooking appliance 2400. Unless otherwise indicated, the cooking appliance 2400 is substantially similar to the cooking appliance 2300 (shown in FIG. 23). In this embodiment, the cooking appliance 2400 has a grate 2402 that includes two rods 2404. Each rod 2404 extends in a serpentine configuration from a first end 2406 to a second end 2408. As compared to the cooking appliance 2300, the serpentine shape of the rods 2404 reduces the complexity of the wiring required for the cooking appliance 2400.

In this example embodiment, each rod 2404 is a heating element, such as cartridge heater. Accordingly, food products cooked on the grate 2402 are in direct contact with heating elements. Alternatively, each rod 2404 may include a heating element inserted within a separate component (e.g., a hollow, winding tube).

In this embodiment, similar to the grate 1900, the wiring for each rod 2404 enters and exits each rod 2404 at the same end (e.g., the first end 2406). Alternatively, for each rod 2404, wiring may enter one end (e.g., the first end 2406) and exit another end (e.g., the second end 2408).

In this embodiment, each of the two rods 2404 are independently controllable. Alternatively, the two rods 2404 are controlled in conjunction with one another. In one embodiment, the temperature of each zone may be set between approximately 300° Fahrenheit (F) and 700° F., and the cooking appliance 2300 operates has a power output of approximately 1400 Watts (W) at 120 Volts (V). Alternatively, the cooking appliance 2300 may have any suitable operating parameters.

A removable drip tray 2418 is positioned below the grate 2402. As shown in FIG. 24, the drip tray 2418 includes a handle 2422 to facilitate removing the drip tray 2418.

FIG. 25 is a perspective view of an alternative cooking appliance 2500. The cooking appliance 2500 includes a grate 2502 positioned on a lower housing 2503. The grate 2302 includes plurality of substantially linear rods 2504 each extending from a first end 2506 to a second end 2508.

In this example embodiment, each rod 2504 is a heating element, such as cartridge heater. Accordingly, food products cooked on the grate 2502 are in direct contact with heating elements. Alternatively, each rod 2504 may include a heating element inserted within a separate component (e.g., a hollow tube). In this embodiment, similar to the grate 1900, the wiring for each rod 2504 enters and exits each rod 2504 at the same end (e.g., the first end 2506). Alternatively, for each rod 2504, wiring may enter one end (e.g., the first end 2506) and exit another end (e.g., the second end 2508).

The cooking appliance includes a cover 2512 pivotably coupled to the lower housing 2503. During cooking, the cover 2512 may be closed to retain smoke generated during cooking. Further, closing the cover 2512 also facilitates more rapid heating of the grate 2502. In this embodiment, the cover 2512 does not include any heating elements. Alternatively, one or more heating elements may be positioned within the cover 2512 to facilitate cooking a food product using the cooking appliance 2500.

The cooking appliance 2500 includes a control interface 2510 that enables a user to control operation (e.g., temperature) of the grate 2502. The control interface 2510 may include buttons, knobs, switches, and/or any other suitable input device that enables a user to operate the cooking appliance 2500.

FIG. 26 is a perspective view of the grate 2502, and a FIG. 27 is a thermal map of the cooking appliance 2500 during cooking. As shown in FIGS. 26 and 27, in this embodiment, the grate 2502 is subdivided into a first zone 2520, a second zone 2522, and a third zone 2524. Each zone 2520, 2522, and 2524 is independently controllable. In this embodiment the first zone 2520 includes six rods 2504, the second zone 2522 includes nine rods 2504, and the third zone 2524 includes ten rods 2504. As shown in FIG. 27, in one example, the first zone 2520 is operated at a lower temperature than the second zone 2522, and the third zone 2524 is operated at a higher temperature than the second zone 2522. In one embodiment, the temperature of each zone may be set between approximately 300° Fahrenheit (F) and 700° F., and the cooking appliance 2500 operates has a power output of approximately 1400 Watts (W) at 120 Volts (V). Alternatively, the cooking appliance 2500 may have any suitable operating parameters.

FIG. 28 is a perspective view of an alternative cooking appliance 2800, and FIG. 29 is a perspective view of the cooking appliance 2800 with a cover 2801 removed. In this embodiment, the cooking appliance 2800 is an outdoor grill. The cooking appliance 2800 includes a grate 2802 positioned on a housing 2803. The grate 2802 includes plurality of substantially linear rods 2804 each extending from a first end 2806 to a second end 2808. Two support surfaces 2805 (e.g., for supporting silverware, grilling utensils, etc.) extend outward from the housing 2803.

In this example embodiment, each rod 2804 is a heating element, such as cartridge heater. Accordingly, food products cooked on the grate 2802 are in direct contact with heating elements. Alternatively, each rod 2804 may include a heating element inserted within a separate component (e.g., a hollow tube). In this embodiment, similar to the grate 1900, the wiring for each rod 2804 enters and exits each rod 2804 at the same end (e.g., the first end 2806). Alternatively, for each rod 2804, wiring may enter one end (e.g., the first end 2806) and exit another end (e.g., the second end 2808).

The cover 2801 is pivotably coupled to the housing 2803. During cooking, the cover 2801 may be closed to retain smoke generated during cooking. Further, closing the cover 2801 also facilitates more rapid heating of the grate 2802.

The cooking appliance 2800 includes a control interface 2810 that enables a user to control operation (e.g., temperature) of the grate 2802. The control interface 2810 may include buttons, knobs, switches, and/or any other suitable input device that enables a user to operate the cooking appliance 2800.

In this embodiment, a drip tray 2818 is positioned below the grate 2802. FIG. 30 is a perspective view of the cooking appliance 2800 with the cover 2801, the grate 2802 and the support surfaces 2805 removed. When cooking a food product, grease from the food product falls through the grate 2802 into the drip tray 2818. As shown in FIG. 30, the drip tray 2818 includes an angled or sloped surface 2830 that causes the grease to flow downward and to the side. The drip tray 2818 incudes a handle 2832 to facilitate removing the drip tray 2818 from the housing 2803.

The cooking appliance 2800 also includes a grease tray 2840 positioned below the drip tray 2818. The drip tray 2818 includes an aperture (not shown) such that grease drains through the aperture and into the grease tray 2840. The grease tray 2840 includes a handle 2842 to facilitate removing the grease tray 2840 from the housing 2803. Notably, the grease tray 2840 is located relatively far away from the grate 2802. Accordingly, even when the grease tray 2840 contains grease, the grease tray 2840 may be relatively cool, allowing a user to safely contact the grease tray 2840.

Using the grate 1900, the cooking appliance 2300, the cooking appliance 2400, the cooking appliance 2500, and/or the cooking appliance 2800 provides advantages over at least some known cooking appliances. For example, the grates described herein provide substantially even heating when cooking a food product. Moreover, in contrast to cooking appliances that heat a first plate and then conduct heat through the first plate to a second plate that contacts the food product, the grates described herein include heating elements that directly contact the food product. That is, using the grates described herein, heat is transferred to the food product primarily through conduction. Using heating elements to heat food directly also reduces the mass of the cooking appliance, as components in which the heating elements would otherwise be embedded are not included.

Further, the grates described herein may be more efficient and capable of achieving higher temperatures than at least some known cooking appliances. For example, at least some known cooking appliances take approximately four seconds to reach a temperature of 400° F., and are unable to reach 700° F. In contrast, the grates described herein may be able to reach 400° F. in approximately two seconds, and may be able to reach 700° F. in approximately seven seconds.

To eliminate switching losses and reduce electromagnetic interference, the cooking appliances described herein may also utilize zero voltage switching. That is, when operating on alternating current (AC) power, the cooking appliances may be activated/deactivated when the input voltage crosses zero. To control temperature, a ratio of on cycles to off cycles for the heating elements may be adjusted accordingly.

In some embodiments, a user may control the cooking appliances described herein using a computing device (e.g., a tablet, a desktop computer, a laptop computer, a mobile phone, etc.), where the computing device communicates remotely with the cooking appliance a wired and/or wireless network, such as the Internet, or any other communications medium (e.g., Bluetooth®). For example, the user may use a software application on a computing device that enables the user to set a temperature and/or cooking time, where the input is communicated from the computing device to cooking appliance. Further, the cooking appliance may communicate information to the computing device (e.g., remaining cooking time, current temperature) to notify the user.

When introducing elements of the present invention or the preferred embodiment(s) thereof, the articles “a”, “an”, “the”, and said are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A cooking appliance comprising:
at least one cooking grate comprising:
a first rail;
a second rail; and
a plurality of rods extending between the first and second rails in spaced relationship with each other, each of the plurality of rods comprising a respective heating element such that the at least one cooking grate facilitates directly contacting a food product with a plurality of the heating elements during cooking.

2. The cooking appliance of claim 1, wherein each heating element comprises a cartridge heater.

3. The cooking appliance of claim 1, wherein each heating element comprises a resistive wire.

4. The cooking appliance of claim 1, further comprising a tray positioned below the at least one cooking grate.

5. The cooking appliance of claim 4, wherein the tray comprises a sloped surface positioned to catch grease from the food product and direct the grease towards one side of the tray.

6. The cooking appliance of claim 1, further comprising a top unit hingedly coupled to a bottom unit.

7. The cooking appliance of claim 6, wherein the at least one cooking grate comprises a first cooking grate housed in the top unit and a second cooking grate housed in the bottom unit.

8. The cooking appliance of claim 1, wherein each heating element is embedded in the respective rod.

9. The cooking appliance of claim 1, wherein each heating element itself forms the respective rod.

10. The cooking appliance of claim 1, wherein the plurality of rods comprises a plurality of linear rods.

11. The cooking appliance of claim 1, wherein the plurality of rods comprises a plurality of serpentine rods.

12. The cooking appliance of claim 1, further comprising a control system configured to:
receive input from a user; and
control operation of the at least one cooking grate based on the user input.

13. The cooking appliance of claim 1, wherein to control operation of the at least one cooking grate, the control system is configured to independently control a plurality of zones of the at least one cooking grate, each zone including at least one of the plurality of rods.

14. The cooking appliance of claim 1, wherein to control operation of the at least one cooking grate, the control system is configured to control operation of the at least one cooking grate using zero voltage switching.

15. A cooking grate for use in a cooking appliance, the cooking grate comprising:
a first rail;
a second rail; and
a plurality of rods extending between the first and second rails in a spaced relationship with each other, each of the plurality of rods comprising a respective heating element such that the at least one cooking grate facilitates directly contacting a food product with a plurality of the heating elements during cooking.

16. The cooking grate of claim 15, wherein each heating element comprises a cartridge heater.

17. The cooking grate of claim 15, wherein each heating element comprises a resistive wire.

18. The cooking grate of claim 15, wherein each heating element itself forms the rod.

19. The cooking grate of claim 15, wherein the plurality of rods comprises a plurality of serpentine rods.

20. The cooking grate of claim 15, wherein the plurality of rods are divided into a plurality of zones, each zone configured to be independently controlled by a control system.
